(19) United States
(12) Patent Application Publication
(10) Pub. No.: US 2021/0159588 A1
(43) Pub. Date: May 27, 2021

(54) ADAPTIVE ANTENNA ARRAY CONFIGURATION FOR A WIRELESS MILLIMETER-WAVE SYSTEM IN A VEHICLE

(71) Applicant: GM Global Technology Operations LLC, Detroit, MI (US)

(72) Inventors: Igal Kotzer, Tel-Aviv (IL); Ofer Givati, Herzliya (IL)

(21) Appl. No.: 16/690,993

(22) Filed: Nov. 21, 2019

(51) Int. Cl. H01Q 1/24; H01Q 1/22; H01Q 1/38

(52) U.S. Cl. CPC H01Q 1/246; H01Q 1/38; H01Q 1/2283

(57) ABSTRACT

A wireless millimeter-wave (mmWave) system in a vehicle and methods for the wireless mmWave system involve determining a direction and orientation for a link from the wireless mmWave system to a node outside the vehicle. A method includes computing an array of antenna elements of the wireless mmWave system to produce a radiation pattern to form the link. The array of the antenna elements is a subset of all the antenna elements of the wireless mmWave system. The array of the antenna elements of the wireless mmWave system are configured to communicate with the node over the link.

### INTRODUCTION

The subject disclosure relates to adaptive antenna array configuration for a wireless millimeter-wave (mmWave) system in a vehicle.

A vehicle (e.g., automobile, truck, construction equipment, farm equipment, automated factory equipment) may include sensors and communication devices to obtain information about the vehicle and its surroundings. The information may facilitate autonomous or semi-autonomous (e.g., collision avoidance, automatic braking) operation of the vehicle as well as communication, such as the transfer of data between vehicles and base stations. The communication may involve data for the infotainment system of the vehicle or telematics data, for example. Exemplary sensors include a camera, light detection and ranging (lidar) system, and radio detection and ranging (radar) system. A wireless mmWave system may provide communication capabilities amongst vehicles (V2V communication) as well as between a vehicle and infrastructure (e.g., base stations) (V2I communication). Unlike in a stationary scenario, the direction and distance from a vehicle to a given entity with which it is communicating (i.e., node in the communications circuit) may change, because the vehicle is a moving platform. Accordingly, it is desirable to provide an adaptive antenna array configuration for a wireless millimeter-wave (mmWave) system in a vehicle.

### SUMMARY

In one exemplary embodiment, a method for a wireless millimeter-wave (mmWave) system in a vehicle includes determining a direction and orientation for a link from the wireless mmWave system to a node outside the vehicle, and computing an array of antenna elements of the wireless mmWave system to produce a radiation pattern to form the link. The array of the antenna elements is a subset of all the antenna elements of the wireless mmWave system. The array of the antenna elements of the wireless mmWave system are configured to communicate with the node over the link.

In addition to one or more of the features described herein, the determining the direction and orientation, the computing the array of antenna elements, and the configuring the array of the antenna elements is iteratively performed continuously while the vehicle is moving.

In addition to one or more of the features described herein, the configuring the array of the antenna elements includes controlling a magnitude and phase of a signal transmitted by each antenna element of the array of antenna elements to produce the radiation pattern.

In addition to one or more of the features described herein, the method also includes transmitting from every one of the antenna elements of the array of the antenna elements simultaneously to produce the radiation pattern.

In addition to one or more of the features described herein, the method also includes determining a second direction and orientation for a second link to a second node, and computing a second array of the antenna elements of the wireless mmWave system to produce a second radiation pattern to form the second link.

In addition to one or more of the features described herein, the method also includes transmitting the radiation pattern using the array of the antenna elements simultaneously with transmitting the second radiation pattern using the second array of the antenna elements.

In addition to one or more of the features described herein, the method also includes computing an additional array of the antenna elements of the wireless mmWave system to produce an additional radiation pattern directed to the node. Producing the additional radiation pattern includes the radiation pattern being uncorrelated with the additional radiation pattern.

In addition to one or more of the features described herein, the method also includes using a switching matrix to adaptively define the array of the antenna elements.

In addition to one or more of the features described herein, the method also includes transferring data from one or more sensors of the vehicle to the node using the array of the antenna elements. The transferring the data from the one or more sensors of the vehicle includes transferring data from a radar system, a lidar system, or a camera.

In addition to one or more of the features described herein, the method also includes receiving data at the vehicle from the node using the array of the antenna elements.

In another exemplary embodiment, a system in a vehicle includes a wireless millimeter-wave (mmWave) system in the vehicle that includes antenna elements for transmission and reception in a millimeter wavelength range. The system also includes a controller to determine a direction and orientation for a link from the wireless mmWave system to a node outside the vehicle, and to compute an array of the antenna elements of the wireless mmWave system to produce a radiation pattern to form the link. The array of the antenna elements is a subset of all the antenna elements of the wireless mmWave system. The controller also configures the array of the antenna elements of the wireless mmWave system to communicate with the node over the link.

In addition to one or more of the features described herein, the controller iteratively determines the direction and orientation, compute the array of antenna elements, and configure the array of the antenna elements continuously while the vehicle is moving.

In addition to one or more of the features described herein, the controller configures the array of the antenna elements by controlling a magnitude and phase of a signal transmitted by each antenna element of the array of antenna elements to produce the radiation pattern.

In addition to one or more of the features described herein, every one of the antenna elements of the array of the antenna elements transmits simultaneously to produce the radiation pattern.

In addition to one or more of the features described herein, the controller determines a second direction and orientation for a second link to a second node, and computes a second array of the antenna elements of the wireless mmWave system to produce a second radiation pattern to form the second link.

In addition to one or more of the features described herein, the radiation pattern is transmitted by the array of the antenna elements simultaneously with the second radiation pattern by the second array of the antenna elements.

In addition to one or more of the features described herein, the controller computes an additional array of the antenna elements of the wireless mmWave system to produce an additional radiation pattern directed to the node, and controls the radiation pattern to be uncorrelated with the additional radiation pattern.

In addition to one or more of the features described herein, the system also includes a switching matrix configured to adaptively define the array of the antenna elements.

In addition to one or more of the features described herein, the wireless mmWave system transfers data from one or more sensors of the vehicle to the node using the array of the antenna elements, the one or more sensors including a radar system, a lidar system, or a camera.

In addition to one or more of the features described herein, the wireless mmWave system receives data from the node using the array of the antenna elements.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of an exemplary vehicle with a wireless mmWave system that includes an adaptive antenna array configuration according to one or more embodiments;

FIGS. 2A, 2B, and 2C show exemplary embodiments of antenna elements disposed on three-dimensional shapes to facilitate adaptive antenna array configuration according to one or more embodiments;

FIG. 3 illustrates exemplary adaptive antenna array configuration for a vehicle wireless mmWave system according to one or more embodiments;

FIG. 4 is a block diagram of relevant aspects of the wireless mmWave system used to perform adaptive antenna array configuration according to one or more embodiments;

FIG. 5 is a block diagram of an exemplary RF chain that may be adaptively coupled to an antenna element to configure antenna arrays according to one or more embodiments;

FIG. 6 is a block diagram detailing the beam steering unit shown in FIG. 5; and

FIG. 7 is a process flow of a method of adaptively configuring antenna arrays in a vehicle wireless mmWave system according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a wireless mmWave system is among the exemplary communication systems that a vehicle may use. The mmWave system facilitates high-speed data transfer. Due to the fact that a vehicle application involves a moving platform, the orientation between the wireless mmWave system and the node with which the wireless mmWave system communicates (generally a base station or another vehicle) may change in real-time. For example, the orientation between the wireless mmWave system of the vehicle and a node may change during the transfer of large data files.

Embodiments of the systems and methods detailed herein relate to providing an adaptive antenna array configuration for a vehicle wireless mmWave system. Antenna elements that are active radiators are distributed over a three-dimensional or planar shape are adaptively selected for operation. The selected antenna elements form one or more antenna arrays. At different times, different antenna elements may be grouped together to form one or more arrays. Beamforming may be performed by applying a different amplitude and phase values to the signal provided to each antenna element of an array. The selection of the antenna elements for operation (i.e., transmission and reception) may be based on directivity, main lobe beamwidth, or gain to optimize radio frequency (RF) link quality, for example. The examples discussed herein are not intended to limit the basis by which antenna arrays are adaptively formed.

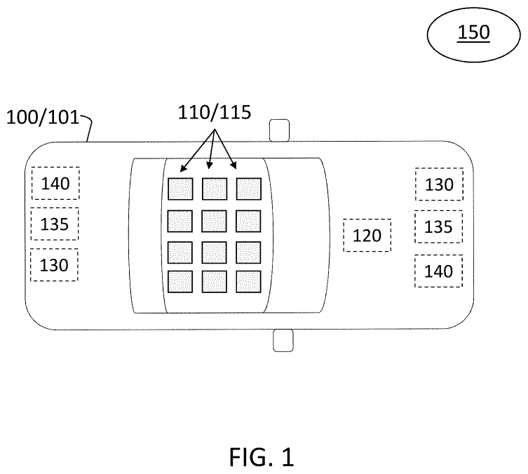

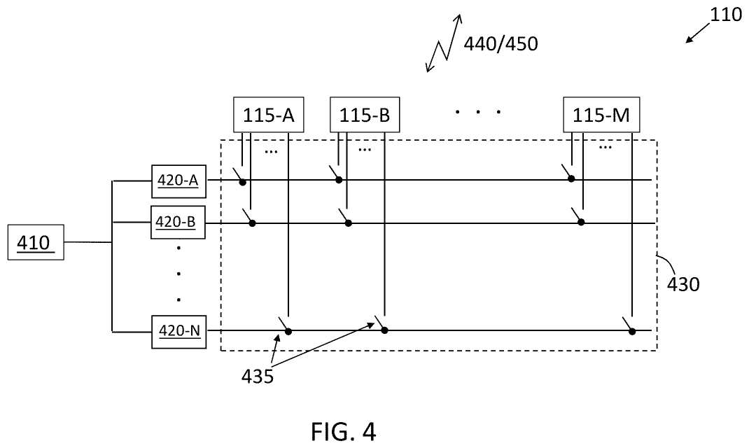

In accordance with an exemplary embodiment, FIG. 1 is a block diagram of an exemplary vehicle 100 with a wireless mmWave system that includes an adaptive antenna array configuration. The exemplary vehicle 100 in FIG. 1 is an automobile 101. The vehicle 100 is shown with a wireless mmWave system 110 that includes a set of antenna elements 115. Additional aspects of the wireless mmWave system 110 are discussed with reference to FIGS. 4-7. Generally, a wireless mmWave system transmits and receives signals at frequencies between 30 gigahertz (GHz) and 300 GHz. The wireless mmWave system 110 of a vehicle 100 may transmit and receive signals in the 28 GHz or 39 GHz frequency bands. In the exemplary case shown in FIG. 1, the antenna elements 115 are arranged on the planar roof of the vehicle 100.

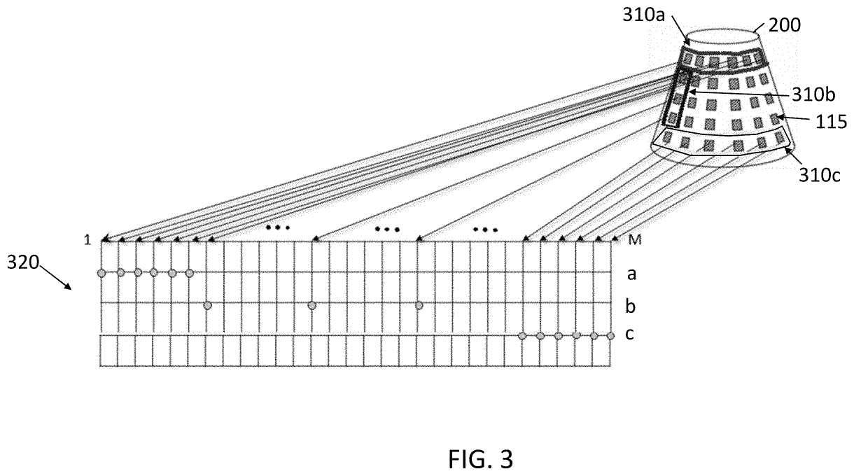

The exemplary vehicle 100 is shown with other sensors such as cameras 130, a radar system 135, and a lidar system 140. The numbers and locations of the sensors are not intended to be limited by the example. According to one or more embodiments, information from one or more of these other sensors may be transferred outside the vehicle 100 via a node 150 (e.g., base station, another vehicle). While one exemplary node 150 is shown in FIG. 1, there may be multiple nodes 150 in the line of sight of the vehicle 100 at a given position and as it moves. As previously noted, maintenance of the RF link between the vehicle 100 and the base stations requires adaptively configuring one or more antenna arrays 310 (FIG. 3) from the antenna elements 115. A controller 120 is shown in the exemplary vehicle 100, as well. The controller 120 may be comprised of two or more controllers 120 that communicate with each other to perform the functionality described. The controller 120 may obtain information from other sensors or other sources to direct the adaptive configuration of different antenna arrays 310.

The controller 120 may be used to transfer information to and from the wireless mmWave system 110. Information obtained by the wireless mmWave system 110 and other sensors and sources of information may be used to control aspects of the operation of the vehicle 100. For example, semi-autonomous systems (e.g., adaptive cruise control, collision avoidance, automatic braking) or autonomous operation may be controlled by the information transferred via controller 120. The controller 120 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

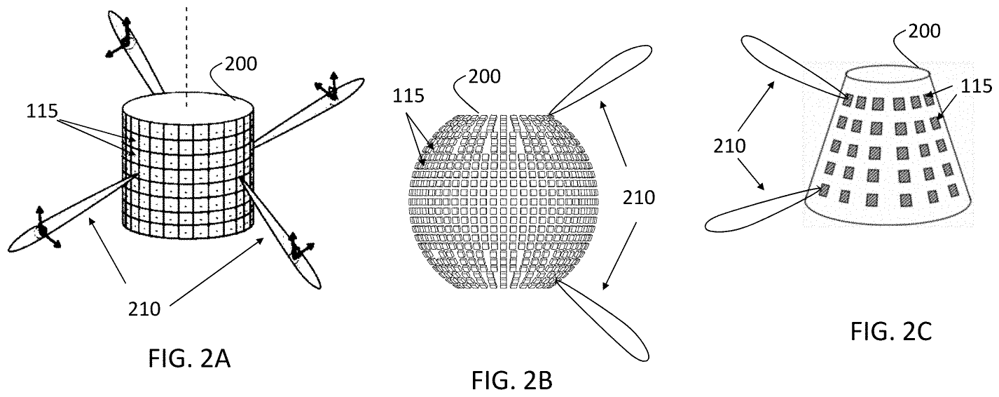

FIGS. 2A, 2B, and 2C show exemplary embodiments of antenna elements 115 disposed on three-dimensional shapes 200. FIG. 2A shows antenna elements 115 on a three-dimensional shape 200 that is a cylindrical shape. Exemplary antenna beams 210 are also indicated. The exemplary antenna beams 210 are at the same elevation but adjacent antenna beams 210 are ninety degrees apart. FIG. 2B shows antenna elements 115 on a three-dimensional shape 200 that resembles a sphere without the two poles. Because of this shape, the beam pattern solid angle for many of the antenna elements 115 include both an azimuth and elevation offset. As a result, the beam characteristics for the exemplary beams 210, for example, may be improved relative to beams steered in the same directions using one or an array of antenna elements 115 of the three-dimensional shape 200 in FIG. 2A, for example. The exemplary three-dimensional shape 200 shown in FIG. 2B may be advantageous when the wireless mmWave system 110 is required to communicate with multiple nodes 150 concurrently, for example. FIG. 2C shows an exemplary three-dimensional shape 200, on which the antenna elements 115 are disposed, that is like a truncated cone (i.e., a frustoconical shape).

FIG. 3 illustrates exemplary adaptive antenna array configuration for a vehicle wireless mmWave system 110 according to one or more embodiments. There are M antenna elements 115 disposed on the three-dimensional shape 200 shown in FIG. 3. Three different antenna arrays 310a, 310b, 310c (generally referred to as 310) are adaptively configured from the M antenna elements 115. The antenna array 310a includes six of the antenna elements 115, as indicated in the matrix 320 with dots. That is, matrix 320 includes dots corresponding to each of the antenna elements 115 that forms an active antenna array 310. The antenna array 310b includes three antenna elements 115, and the antenna array 310c includes six antenna elements 115. Other exemplary antenna arrays 310 may reuse antenna elements 115 that are part of any of the exemplary antenna arrays 310a, 310b, 310c.

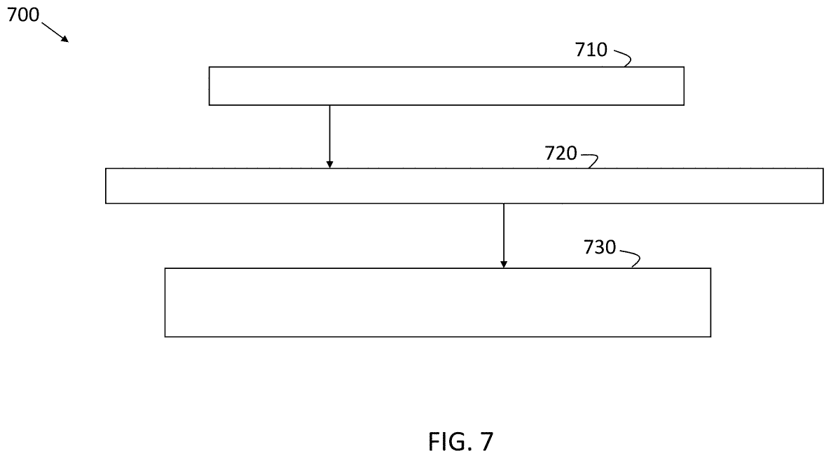

FIG. 4 is a block diagram of relevant aspects of the wireless mmWave system 110 used to perform adaptive antenna array configuration according to one or more embodiments. The wireless mmWave system 110 includes a wireless mmWave controller 410, N RF chains 420-A through 420-N (generally referred to as 420), a switching matrix 430, and M antenna elements 115-A through 115-M (generally 115). Generally, there can be as many or fewer RF chains 420 as antenna elements 115 (i.e., N may be less than or equal to M). The wireless mmWave controller 410 determines which of the RF chains 420 will be operable and which one or more antenna elements 115 will be excited by the operating RF chains 420. This determination by the wireless mmWave controller 410 is further discussed with reference to FIG. 7. The implementation of this determination is through the switching matrix 430. Thus, the matrix 320 shown in FIG. 3 may be regarded as the result of one exemplary setting of the switching matrix 430. The exemplary switching matrix 430 includes controllable switches 435 from each RF chain 420 to each antenna element 115. All the switches 435 are shown in the off (disconnected) position, prior to the configuration of any antenna arrays 310. While an exemplary switching matrix 430 including the switches 435 is shown in FIG. 4, other mechanisms may be used to connect one or more RF chains 420 to antenna elements 115 according to alternate embodiments.

According to an exemplary embodiment, the switching matrix 430 may include a splitter at each RF chain 420 to split the output from and the input to the RF chain 420 M ways. Each of these M input and output pairs may be provided to a switch at each of the M antenna elements 115. The wireless mmWave controller 410 may include a clock and field programmable gate array (FPGA), and, like the controller 120 of the vehicle 100, may include other processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

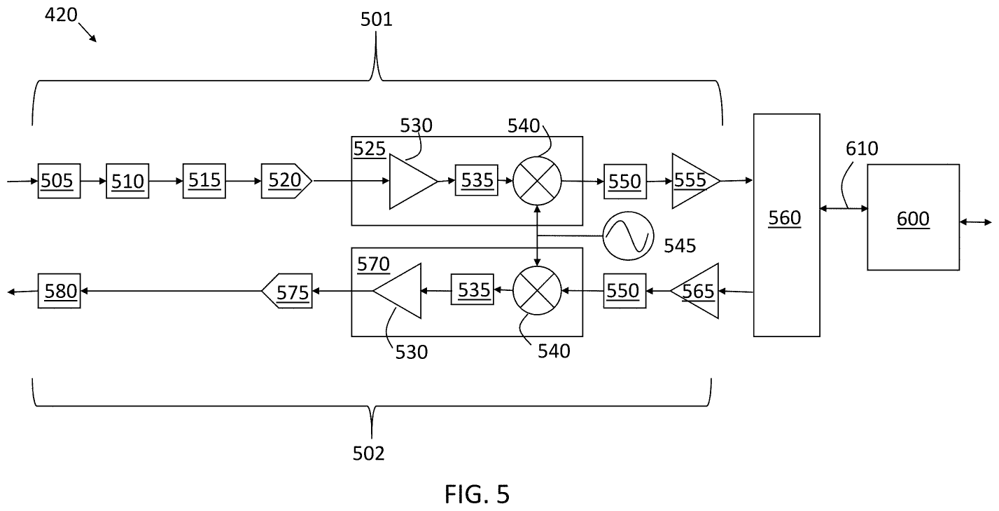

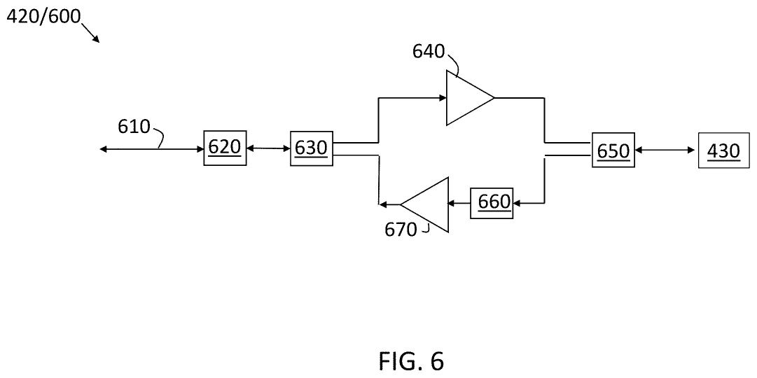

At one extreme, a single RF chain 420 may generate and supply a transmit signal 440 to each of the M antenna elements 115 through the switching matrix 430. Received signals 450 at each of the M antenna elements 115 are then provided to the single RF chain 420 through the switching matrix 430. At another extreme, every RF chain 420 may generate and supply a transmit signal 440 to a corresponding antenna element 115 through the switching matrix 430. Generally, some subset K of the N RF chains 420 may be adaptively coupled through the switching matrix 430 to a corresponding subset K of the M antenna elements 115 to form antenna arrays 310 like the exemplary antenna arrays 310 shown in FIG. 3. An exemplary implementation of an RF chain 420 is detailed with reference to FIGS. 5 and 6.

FIG. 5 is a block diagram of an exemplary RF chain 420 that may be adaptively coupled to an antenna element 115 to configure antenna arrays 310 according to one or more embodiments. Each exemplary RF chain 420 includes transmit components 501 and receive components 502. The transmit components 501 include a digital up conversion unit 505, crest factor reduction unit 510, and digital pre-distortion unit 515. The output of the digital pre-distortion unit 515 is provided to a digital-to-analog converter (DAC) 520, and the resulting analog signal is provided to an up-converter 525. The analog signal from the DAC 520 is at an intermediate frequency (e.g., 20 megahertz (MHz)). The up-converter 525 includes a variable gain amplifier (VGA) 530, low-pass filter 535, and mixer 540 that is supplied by an oscillator 545. The up-converter output is provided to a bandpass filter 550 and a power amplifier (PA) 555. A duplexer 560 sends the signal from the transmit components 501 out to a beam steering unit 600 for transmission (e.g., to a node 150 in the line of sight of the vehicle 100). In alternate RF chain 420 implementations, a diplexer or transmit and receive switch may be used instead. A received signal (e.g., from a node 150 with the vehicle 100 in its line of sight) is processed by the receive components 502. The signals to and from the beam steering unit 600 are RF signals 610. The beam steering unit 600 is used to shift the amplitude and phase of the RF signal 610 to perform beamforming and is further discussed with reference to FIG. 6.

The received components 502 include a low noise amplifier (LNA) 565 followed by a bandpass filter 550. The bandpass filter 550 output is provided to a down-converter 570. The down-converter 570 includes a mixer 540 that is also supplied by the oscillator 545, a low-pass filter 535, and a VGA 530. The output of the down-converter 570 is provided to an analog-to-digital converter (ADC) 575. The resulting digital signal is provided to a digital down-conversion unit 580. Other known elements and aspects of a wireless mmWave system 110 are not detailed.

FIG. 6 is a block diagram detailing aspects of the beam steering unit 600 shown in FIG. 5. Continuing reference is made to the preceding figures. The beam steerering unit 600 may be used as part of the RF chain 420 to perform beamforming with an adaptively configured antenna array 310. An RF signal 610 coming from the transmit components 501 of the RF chain 420 is provided to a phase shifter 620. The phase-shifted RF signal that results is sent to a switch 630 that separates transmit side 501 and the receive side 502 of the beam steering unit 600. The switch 630 may be a single pole double throw switch, for example. On the transmit side 501, a PA 640 amplifies the phase-shifted RF signal and provides it to another switch 650 for output to the switching matrix 430. When a received signal 450 comes through the switching matrix 430 to the switch 650, the receive side 502 of the RF chain 420 is used. A limiter 660 is followed by an LNA 670. The output of the LNA 670 is provided to the switch 630, which directs it to the phase shifter 620. The phase shifter provides the resulting RF signal 610 to the duplexer 560.

FIG. 7 is a process flow of a method 700 of adaptively configuring antenna arrays 310 in a vehicle wireless mmWave system 110 according to one or more embodiments. Continuing reference is made to the previous figures. The processes shown in FIG. 7 may be performed by the controller 120, by the wireless mmWave system controller 410, or by a combination of the two. At block 710, determining the direction and orientation of a desired link may be performed at any time during operation of the wireless mmWave system 110 in the vehicle 100. For example, all the antenna elements 115 may be used individually for scanning (e.g., receiving broadcasts from nodes 150 within the line of sight of the wireless mmWave system 110). Then, the relative strength of received signals 450 with the different antenna elements 115 may be used to locate one or more nodes 150 of interest. The direction and orientation to each node 150 defines each desired link.

At block 720, computing the combination of antenna elements 115 to generate the one or more radiation patterns refers to determining the antenna elements 115 needed for one or more antenna arrays 310 to form the desired one or more links. At block 730, the processes include configuring the antenna elements 115 of one or more antenna arrays 310 and assigning a magnitude and phase to each antenna element 115 to achieve the one or more radiation patterns needed for the one or more links. The processes at blocks 710, 720, and 730 may be performed continuously when the vehicle 100 is moving, because the direction and orientation of one or more desired links may change. As a result, an antenna array 310 may need to be reconfigured to maintain the link. As one node 150 drops out of the line of sight of the wireless mmWave system 110 and another node 150 comes into the line of sight, the desired link and the corresponding antenna elements 115 may change accordingly. Assigning a particular magnitude and phase to each antenna element 115 in each antenna array 310 is part of the process of generating the desired radiation pattern.

When two or more antenna arrays 310 are configured (at block 730) to communicate with the same node 150 (e.g., to increase the throughput of a data transfer), the radiation patterns from the different antenna arrays 310 directed to the same node 150 are generated to be uncorrelated. This means that, for example, the radiation patterns transmitted by each of the antenna arrays 310 are directed to different antennas of the node 150 in a way that ensures that the radiation patterns do not overlap. The lack of overlap means that there is no interference between the radiation patterns transmitted by the antenna arrays 310. As another example, orthogonal polarization is used for each of the antenna arrays 310 to eliminate interference between the radiation patterns transmitted by the antenna arrays 310. Within a given antenna array 310, the antenna elements 115 transmit simultaneously and receive simultaneously. Among two or more antenna arrays 310 that are configured (at block 730) for two or more links, the antenna arrays 310 may transmit radiation patterns simultaneously or in turn.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method for a wireless millimeter-wave (mmWave) system in a vehicle, the method comprising:
determining, using a controller, a direction and orientation for a link from the wireless mmWave system to a node outside the vehicle;
computing, using the controller, an array of antenna elements of the wireless mmWave system to produce a radiation pattern to form the link, wherein the array of the antenna elements is a subset of all the antenna elements of the wireless mmWave system; and
using a switching matrix to select the array of the antenna elements, wherein the switching matrix adaptively couples a set of radio frequency chains, each of which includes transmit and receive components; to all the antenna elements of the wireless mmWave system; and
configuring the array of the antenna elements of the wireless mmWave system to communicate with the node over the link based on the switching matrix coupling the array of the antenna elements of the wireless mmWave system to the radio frequency chain among the set of radio frequency chains that defines the radiation pattern.

2. The method according to claim 1, wherein the determining the direction and orientation, the computing the array of antenna elements, and the configuring the array of the antenna elements is iteratively performed continuously while the vehicle is moving.

3. The method according to claim 1, wherein the configuring the array of the antenna elements includes controlling a magnitude and phase of a signal transmitted by each antenna element of the array of antenna elements to produce the radiation pattern.

4. The method according to claim 3, further comprising transmitting from every one of the antenna elements of the array of the antenna elements simultaneously to produce the radiation pattern.

5. The method according to claim 1, further comprising determining a second direction and orientation for a second link to a second node, and computing a second array of the antenna elements of the wireless mmWave system to produce a second radiation pattern to form the second link.

6. The method according to claim 5, further comprising transmitting the radiation pattern using the array of the antenna elements simultaneously with transmitting the second radiation pattern using the second array of the antenna elements.

7. The method according to claim 1, further comprising computing an additional array of the antenna elements of the wireless mmWave system to produce an additional radiation pattern directed to the node, wherein producing the additional radiation pattern includes the radiation pattern being uncorrelated with the additional radiation pattern.

8. The method according to claim 1, further comprising using a switching matrix to adaptively define the array of the antenna elements.

9. The method according to claim 1, further comprising transferring data from one or more sensors of the vehicle to the node using the array of the antenna elements, wherein the transferring the data from the one or more sensors of the vehicle includes transferring data from a radar system, a lidar system, or a camera.

10. The method according to claim 9, further comprising receiving data at the vehicle from the node using the array of the antenna elements.

11. A system in a vehicle, the system comprising:
a wireless millimeter-wave (mmWave) system in the vehicle that includes antenna elements for transmission and reception in a millimeter wavelength range; and
a switching matrix configured to adaptively couple a set of radio frequency chains, each of which includes transmit and receive components; to the antenna elements of the wireless mmWave system; and
a controller configured to determine a direction and orientation for a link from the wireless mmWave system to a node outside the vehicle, to compute an array of the antenna elements of the wireless mmWave system to produce a radiation pattern to form the link, wherein the array of the antenna elements is a subset of all the antenna elements of the wireless mmWave system, and to configure the array of the antenna elements of the wireless mmWave system to communicate with the node over the link by using the switching matrix to couple the array of the antenna elements of the wireless mmWave system to the radio frequency chain among the set of radio frequency chains that defines the radiation pattern.

12. The system according to claim 11, wherein the controller is configured to iteratively determine the direction and orientation, compute the array of antenna elements, and configure the array of the antenna elements continuously while the vehicle is moving.

13. The system according to claim 11, wherein the controller is configured to configure the array of the antenna elements by controlling a magnitude and phase of a signal transmitted by each antenna element of the array of antenna elements to produce the radiation pattern.

14. The system according to claim 13, wherein every one of the antenna elements of the array of the antenna elements is configured to transmit simultaneously to produce the radiation pattern.

15. The system according to claim 11, wherein the controller is further configured to determine a second direction and orientation for a second link to a second node, and to compute a second array of the antenna elements of the wireless mmWave system to produce a second radiation pattern to form the second link.

16. The system according to claim 15, wherein the radiation pattern is configured to be transmitted by the array of the antenna elements simultaneously with the second radiation pattern by the second array of the antenna elements.

17. The system according to claim 11, wherein the controller is further configured to compute an additional array of the antenna elements of the wireless mmWave system to produce an additional radiation pattern directed to the node, and radiation pattern is controlled to be uncorrelated with the additional radiation pattern.

18. The system according to claim 11, further comprising a switching matrix configured to adaptively define the array of the antenna elements.

19. The system according to claim 11, wherein the wireless mmWave system is configured to transfer data from one or more sensors of the vehicle to the node using the array of the antenna elements, the one or more sensors including a radar system, a lidar system, or a camera.

20. The system according to claim 19, wherein the wireless mmWave system is configured to receive data from the node using the array of the antenna elements.
